(19) United States
(12) Patent Application Publication
(10) Pub. No.: US 2012/0145763 A1
(43) Pub. Date: Jun. 14, 2012

(54) FASTENER-DRIVING APPARATUS

(75) Inventors: Tilo DITTRICH, Feldkrich (AT); Norbert Heeb, Buchs (CH); Simon Beauvais, Horbranz (AT)

(73) Assignee: Hilti Aktiengesellschaft, Schaan (LI)

(21) Appl. No.: 13/323,065

(22) Filed: Dec. 12, 2011

(30) Foreign Application Priority Data
Dec. 13, 2010 (DE) 102010062962.6

(51) Int. Cl. B25C 1/18; B25C 1/14

(52) U.S. Cl. 227/10

(57) ABSTRACT

The invention concerns a driving apparatus comprising a tank (5) for storage of a fuel, in particular a liquefied gas, a combustion chamber (3) connected to the tank (5) via a valve element (6), where the combustion chamber (3) has a movable piston (3a) to drive a driving ram, and an ignition device (11) to ignite an air-fuel mixture in the combustion chamber (3), where in the combustion chamber an evaporation element (8) is provided, where injection of the fuel is aimed at the evaporation element (8).

The invention concerns a fastener-driving apparatus, in particular a hand-operated driving apparatus, according to the generic part of claim 1.

U.S. Pat. No. 4,913,331 describes a gas-driven driving apparatus, in which liquefied gas is injected into a first combustion chamber from a supply container via a valve. Adjacent to the first combustion chamber are additional chambers, each separated by separating walls provided with orifices, through which reduced consumption is supposed to be achieved.

In general with devices driven with a combustible fuel, in particular liquefied gas, there is the problem of sufficiently rapid and complete evaporation of the fuel injected into the combustion chamber.

It is the task of the invention to specify a driving apparatus in which gasification and/or mixing of the fuel is improved.

This task is solved in accordance with the invention for a said driving apparatus with the characterizing features of claim 1. Through the passive evaporation element onto which the injected fuel (preferably liquefied gas such as propane) is directed, the evaporation and/or the distribution of the fuel can be improved with simple means. The evaporation element can operate even in a cold state, for instance by atomizing the fuel better by impact and/or distributing it over a larger area. Moreover, the evaporation element can become heated in the course of one or more initial combustion operations, so that subsequent injections of fuel are evaporated even better.

In a possible further development of the invention, it is conceivable that the evaporation element is heated by means of an external energy source, for example an electric heating element, before a first combustion operation. However, for simplification and reduction of cost the evaporation element is preferably designed as a completely passive element that is not associated with an external energy source.

In a generally advantageous way it is provided that the evaporation element project into the free combustion space in the combustion chamber. Through this, combustion is not hindered by the evaporation element, and pressure waves that arise in the course of combustion can easily flow around the evaporation element. In this regard it is especially preferably provided that the evaporation element not extend completely through the combustion chamber.

In a possible further development of the invention, the evaporation element essentially extends in one plane, where the plane is tilted in particular by a tilt angle of less than 90° to the direction of injection of the fuel onto the evaporation element and/or to a central axis of the combustion chamber. Especially preferably, the tilt angle is between about 20° and about 70°. Through this, in particular in combination with side injection, effective distribution and evaporation of the fuel can take place without the expansion of the ignited gas or the course of combustion being hindered by the evaporation element.

In order to hinder the expansion of the gas and propagation of combustion as little as possible, it is provided in a preferred further development that the area covered by the evaporation element amounts to no more than two-thirds, especially no more than half, of the cross-sectional area of the injected jet of the fuel onto the evaporation element and/or not more than half of the cross-sectional area of the combustion chamber (3) perpendicular to the central axis of the combustion chamber (3). The central axis in this case is usually understood to be the axis of the direction of travel of the driving rod.

Generally advantageously, the evaporation element comprises a plurality of openings, where preferably, but not necessarily, a part of a fuel jet directed onto the evaporation element passes through the openings. Through this, an additional dividing and atomization of the fuel is enabled in a simple way. Moreover, through this the evaporation element has a larger surface, which improves the evaporation of adhering fuel. Alternatively or in addition, the surface can also be increased by measures such as fins, knobs or the like on the evaporation element. In an optimized embodiment the openings occupy between about 20% and about 70% of the surface of the evaporation element.

In an expedient and cost-favorable detailed design, the evaporation element is made as an element taken from the group consisting of perforated sheets, wire gauze or gratings. Perforated sheets of various thicknesses and hole sizes, wire gauze and grating can be obtained cheaply as intermediate products made of various materials.

Generally advantageously, the evaporation element consists of a metal such as steel or copper. The heat capacity and thermal conductivity can be optimized in combination with the size of the evaporation element as a function of the average injected amount of fuel. The parameters are selected so that, on the one hand, heating of the evaporation element that is as rapid as possible takes place (total heat capacity as low as possible), while on the other hand, the stored heat is sufficient to evaporate the injected amount of fuel efficiently or without a considerable drop of temperature at the evaporation element.

In a preferred detailed design at least some of the openings in the evaporation element are large enough to enable the penetration of flame through the openings. Preferably, the openings have a cross-sectional area of 4 mm² or more than 4 mm². This guarantees an as rapid as possible spreading of the flame front after ignition.

A preferred embodiment is characterized in that the combustion chamber has an injector that can be connected to the tank via the valve member and which is intended to generate an especially cone-shaped fuel jet going into the combustion chamber.

A preferred embodiment is characterized in that the injector is aimed at the evaporation element. According to an especially preferred embodiment, the evaporation element completely covers the cross section of the fuel jet. According to another especially preferred embodiment, the evaporation element only partly covers the cross section of the fuel jet.

According to a preferred embodiment, the evaporation element comprises a jet divider to divide the fuel jet injected into the combustion chamber into two or more partial jets. The evaporation and/or distribution of the fuel in the combustion chamber is improved by this.

Other advantages and features follow from the embodiment example described below as well as from the dependent claims.

A preferred embodiment of the invention is described below and explained in more detail by means of the attached drawings.

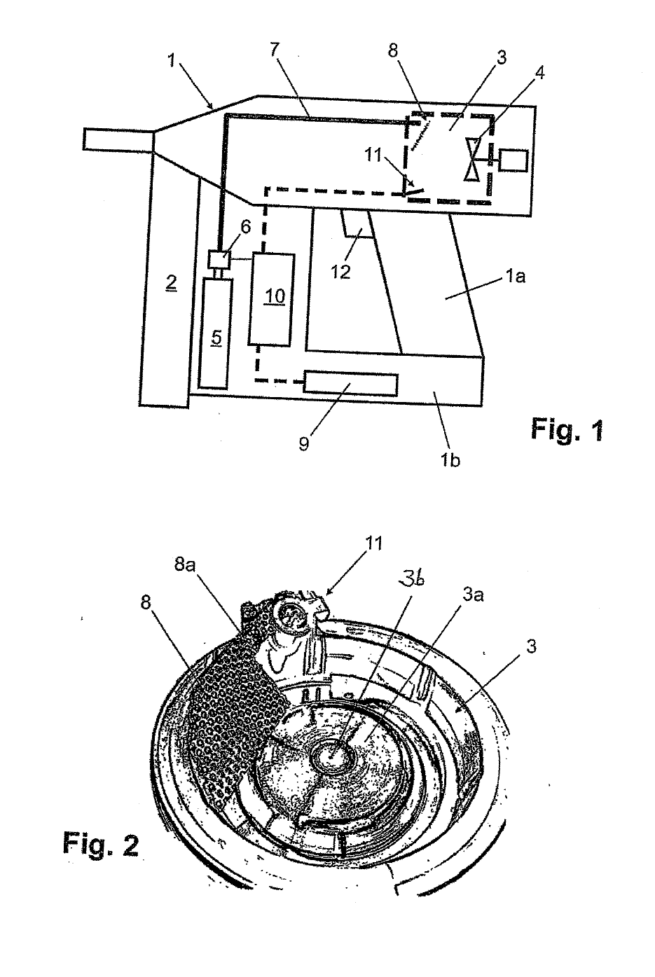

FIG. 1 shows a schematic sectional view of a fastener-driving apparatus in accordance with the invention.

FIG. 2 shows a photographic image of the exposed fuel chamber of an exemplary realization of the driving apparatus in FIG. 1.

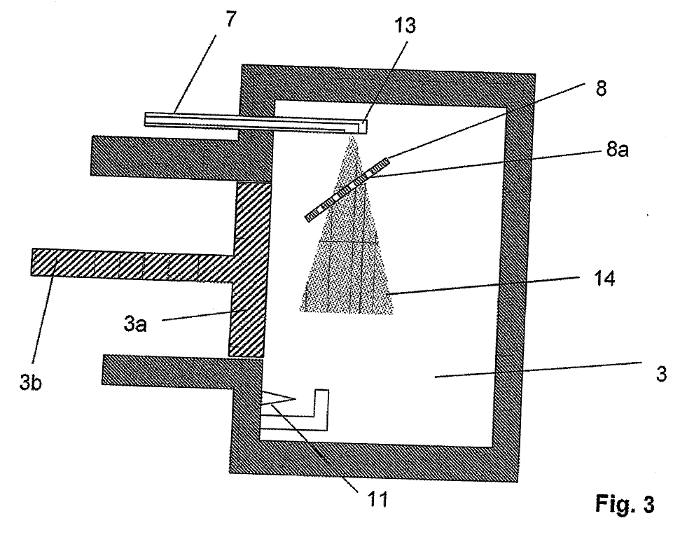

FIG. 3 shows a schematic partial sectional view of a driving apparatus in accordance with the invention.

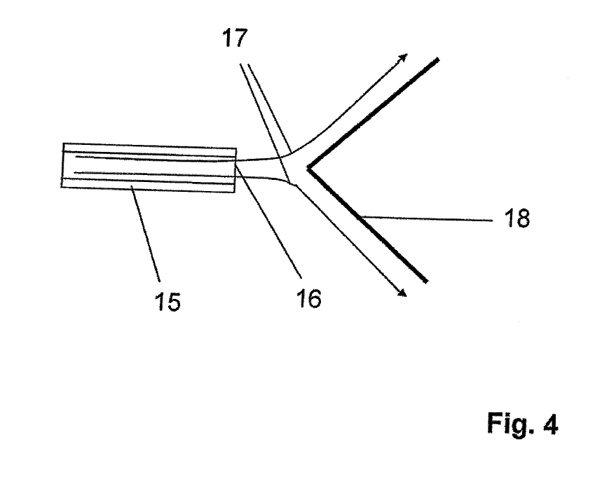

FIG. 4 shows a schematic partial view of a combustion chamber of a driving apparatus in accordance with the invention.

The hand-operated driving apparatus shown in FIG. 1 has a housing 1 with a handle region 1a, a lower and front housing surround 1b and a magazine 2 to hold nails or other drivable fastening elements that is connected to the front region 1b.

In housing 1 is arranged a combustion chamber 3, to which connects a piston 3a that is solidly connected to a driving ram 3b. In addition, an electrically driven fan 4 is situated in the combustion chamber 3 in order to improve the mixing of air and fuel and the exchange of exhaust gas and fresh air.

The fuel is stored in a tank 5 in a lower region of housing 1. The fuel is a liquefied gas, for example propane or another suitable gas. Tank 5 thus is a pressurized storage means. It can be made as a refillable tank that is arranged on the housing 1 permanently and fixed in place, or as an exchangeable cartridge or the like. Tank 5 is connected to a valve element 6 via a tubing segment, where the dispensing of the liquefied gas for injection into the combustion chamber 5 is undertaken via the valve element 6.

Tank 5 for storage of liquefied gas as fuel is accommodated in the housing surround 1b, and the valve element 6 is connected to tank 5, with an injection line 7 going from valve 6 to combustion chamber 3. The injection line 7 enters the combustion chamber 3 in the vicinity of a passive evaporation element 8 in accordance with the invention.

In addition, an electrical energy storage means 9 in the form of a battery is provided in the housing surround. It provides power to the control electronics 10, via which, on the one hand, the valve element is electrically controlled and, on the other, a spark plug 11 arranged in the combustion chamber 3 to generate a spark is electrically supplied. The control electronics 10 is moreover connected to a trigger switch 12 arranged in the handle region 1a so that the operator can initiate the process of fuel injection and spark ignition in the combustion chamber 3 in a controlled way.

The evaporation element 8 in this case is formed as an essentially flat section of a perforated sheet. The section is oriented at an angle of about 45° to the central axis of the combustion chamber 3 or the direction of travel of piston 3a, with its free end unsupported. In this regard see in particular FIG. 2, which shows a photographic image of an open combustion chamber. In this case the rear part of the combustion chamber 3 in the region of the fan 4 has been removed. The spark plug 11 fits into the cylindrical wall of the combustion chamber 3. A fan-shaped segment 8 of the perforated sheet is affixed immediately adjacent to spark plug 11. The part of the perforated sheet adjacent thereto is essentially shaped as a segment of a circle and covers the outlet of the injection line, which ends under the perforated sheet 8 and is not visible in the image.

As can be seen, the segment 8 of the perforated sheet, or the evaporation element, only partially penetrates the free cylindrical space of the combustion chamber 3, where the area covered by the perforated sheet corresponds only to about a fourth of the cross-sectional area of the cylindrical combustion chamber running perpendicular to the central axis.

The invention now functions as follows:

Through the actuation of switch 12, a specific amount of liquefied gas is released from tank 5 into line 7 by the control electronics and injected into combustion chamber 3. The liquefied gas strikes the perforated sheet 8 (from below in the view of FIG. 2), so that the jet of fuel is divided and atomized. A part of the fuel goes through the openings, or holes, 8a of perforated sheet 8, possibly by being deflected and/or atomized at the edges of the holes. Another part remains adhering to the surface of the perforated sheet, where it rapidly evaporates because of the large surface.

The effect of evaporation becomes favored even more after one or more initial combustion processes, since the evaporation element has then become heated.

Since atomization/evaporation is favored by the perforated sheet 8, the spark plug 11 is expediently arranged in the immediate vicinity of perforated sheet 8.

The cross-sectional area of holes 8a in this case is about 30-50% of the area of the perforated sheet. Expediently, the holes are large enough that penetration of flame through the perforated sheet 8 can take place.

The hand-operated driving apparatus shown in part in a sectional view in FIG. 3 has a combustion chamber 3, connected to which is a piston 3a that is solidly connected to a driving ram 3b. In addition, in combustion chamber 3 there is an electrically operated fan (not shown) in order to improve mixing of air and fuel and exchange of exhaust gas and fresh air. The control electronics, likewise not shown, supplies a spark plug 11 arranged in the combustion chamber 3 to generate spark ignition with an electric pulse.

An injection line 7 that can be connected to a fuel tank via a valve element fits into an injector 13 in combustion chamber 3. As soon as a predetermined amount of fuel is dispensed by means of the valve element (not shown), the dispensed fuel flows through the injection line 7 to the injector 13 and is injected into the combustion chamber in the form of a preferably cone-shaped fuel jet 14. For this the injection nozzle is aimed at an evaporation element 8 that is arranged in the combustion chamber 3 so that the evaporation element 8 completely covers a cross section of the fuel jet 14, and the fuel jet 14 only appears on a part of the evaporation element 8.

The evaporation element 8 is in this case made as a flat perforated sheet with holes 8a. The perforated sheet is oriented at an angle of about 30° to the central axis of the combustion chamber and/or the lengthwise direction of the driving ram 3b and/or the direction of travel of piston 3a and is arranged within combustion chamber 3. Holes 8a have a circular or square cross-sectional area and a cross-sectional size of 4 mm², so that penetration of the flame through perforated sheet 8 can take place.

FIG. 4 shows a schematic partial view of a combustion chamber of another driving apparatus in accordance with the invention. A fuel line 15 has an orifice 16 into the combustion chamber, which is not further shown. Fuel flowing through fuel line 15 is sent to the combustion chamber via the orifice 16 in the form of a fuel jet 17. The orifice 16 is designed in particular as an injector, which is connected via the fuel line 15 to a valve element (not shown) and via the valve element to a tank (also not shown).

An evaporation element 18 is arranged in the combustion chamber. The orifice 16 generates the fuel jet 17 and sends it into the combustion chamber and is directed toward the evaporation element 18 so that the fuel jet 17 is also aimed at the evaporation element 18. The evaporation element 18 is designed as a jet divider by having two partial regions set at an angle to each other, which are each tilted by 40° in opposite directions to the injection direction of the fuel jet 17 onto the evaporation element 18 and together completely cover the cross section of the fuel jet 17 leaving the orifice 16. One or more of the angled partial regions of the evaporation element is in each case designed in particular as perforated sheets, wire gauze or gratings.

1. A fastener-driving apparatus comprising
an accommodation for a tank for storing a fuel,
a combustion chamber that can be connected to the tank (5) via a valve element, where the combustion chamber has a movable piston to drive a driver rod, and
an ignition device to ignite an air-fuel mixture in the combustion chamber, and
an evaporation element in the combustion chamber, where injection of the fuel is directed toward the evaporation element.

2. The driving apparatus as in claim 1, wherein the evaporation element projects into a free combustion space of the combustion chamber.

3. The driving apparatus as in claim 2, wherein the evaporation element only partially penetrates the combustion chamber.

4. The driving apparatus as in claim 1, wherein the evaporation element essentially extends in one plane, where the plane is tilted by a tilt angle of less than 90° to the direction of injection of the fuel onto the evaporation element and/or to a central axis of the combustion chamber.

5. The driving apparatus as in claim 4, wherein the tilt angle is between about 20° and about 70°.

6. The driving apparatus as in claim 1, wherein an area covered by the evaporation element amounts to no more than two-thirds of a cross section of an injected jet of fuel onto the evaporation element and/or no more than half a cross-sectional area of the combustion chamber perpendicular to a central axis of the combustion chamber.

7. The driving apparatus as in claim 1, wherein the evaporation element has a plurality of openings, where a part of a fuel jet aimed at the evaporation element passes through the openings.

8. The driving apparatus as in claim 7, wherein the evaporation element has a surface, and the openings take up between about 20% and about 70% of the surface.

9. The driving apparatus as in claim 7, wherein the evaporation element is made as an element from the group consisting of perforated sheets, wire gauze or gratings.

10. The driving apparatus as in claim 7, wherein at least some of the openings are large enough to enable penetration of flame through the openings.

11. The driving apparatus as in claim 1, including a fuel injector, which can be connected to the tank via the valve element, and which is intended to generate a cone-shaped fuel jet going into the combustion chamber.

12. The driving apparatus as in claim 11, wherein the injector is aimed at the evaporation element.

13. The driving apparatus as in claim 11, wherein the evaporation element completely covers a cross section of the fuel jet.

14. The driving apparatus according to claim 11, wherein the evaporation element only partly covers a cross section of the fuel jet.

15. The driving apparatus as in claim 1, wherein the evaporation element is a fuel jet divider.

16. The driving apparatus as in claim 2, wherein the evaporation element essentially extends in one plane, where the plane is tilted by a tilt angle of less than 90° to the direction of injection of the fuel onto the evaporation element and/or to a central axis of the combustion chamber.

17. The driving apparatus as in claim 3, wherein the evaporation element essentially extends in one plane, where the plane is tilted by a tilt angle of less than 90° to the direction of injection of the fuel onto the evaporation element and/or to a central axis of the combustion chamber.

18. The driving apparatus as in claim 16, wherein the tilt angle is between about 20° and about 70°.

19. The driving apparatus as in claim 17, wherein the tilt angle is between about 20° and about 70°.

20. The driving apparatus as in claim 2, wherein an area covered by the evaporation element amounts to no more than two-thirds of a cross section of an injected jet of fuel onto the evaporation element and/or no more than half a cross-sectional area of the combustion chamber perpendicular to a central axis of the combustion chamber.
